(19) United States
(12) Patent Application Publication
(10) Pub. No.: US 2025/0266861 A1
(43) Pub. Date: Aug. 21, 2025

(54) Bandwidth Part Frequency Hopping for Enhanced Reduced Capability UEs

(71) Applicant: Apple Inc., CUPERTINO, CA (US)

(72) Inventors: Hong HE, San Jose, CA (US); Chunhai YAO, Beijing (CN); Chunxuan YE, San Diego, CA (US); Dawei ZHANG, Saratoga, CA (US); Haitong SUN, Saratoga, CA (US); Huaning NIU, San Jose, CA (US); Oghenekome OTERI, San Diego, CA (US); Wei ZENG, Saratoga, CA (US); Weidong YANG, San Diego, CA (US); Yushu ZHANG, Beijing (CN)

(21) Appl. No.: 18/857,317

(22) PCT Filed: Apr. 24, 2022
(86) PCT No.: PCT/CN2022/088751

§ 371 Date: Oct. 16, 2024

(51) Int. Cl. H04B 1/713; H04L 5/00

(52) U.S. Cl. CPC H04B 1/713; H04L 5/001; H04L 5/0044; H04L 5/0094

(57) ABSTRACT

A user equipment (UE) is configured to receive a configuration from a network for parameters including time and frequency resource parameters for a first bandwidth part (BWP) and frequency hopping (FH) parameters for determining time and frequency resource parameters for one or more FH BWPs from the first BWP, determine the time and frequency resource parameters for the one or more FH BWPs based in part on information included in the configuration, the time and frequency resource parameters for the FH BWPs including at least a first physical resource block (PRB) offset between the first BWP and a first FH BWP, receive a scheduling downlink control information (DCI) indicating the first BWP and a subset of the determined FH BWPs are activated for a first channel and perform uplink (UL) or downlink (DL) communications on the first channel in the first BWP and the one or more FH BWPs.

### TECHNICAL FIELD

The present disclosure generally relates to communication, and in particular, to the bandwidth part frequency hopping for enhanced reduced capability UEs.

### BACKGROUND

In a 5G new radio (NR) network, a bandwidth part (BWP) can be configured and activated for a user equipment (UE) so that the UE can transmit a physical uplink shared channel (PUSCH), receive a physical downlink shared channel (PDSCH) and/or perform other functions within the activated resource. For some existing UEs, the UE bandwidth can be 50 MHz or 100 MHZ and include, e.g., up to 273 physical resource blocks (PRBs) for a BWP. For some other UEs, such as enhanced reduced capability (eRedcap) UEs, the UE bandwidth can be as low as 10 MHz or 5 MHz and include, e.g., only up to 11 PRBs. Relative to UEs with a bandwidth of 50 MHz or 100 MHz, a UE with a bandwidth of 5 MHz or 10 MHz would encounter a significant degradation in spectrum efficiency and throughput performance due to the lack of frequency diversity gain caused by the reduced UE bandwidth.

### SUMMARY—TO BE COMPLETED WHEN CLAIMS ARE FINALIZED

Some exemplary embodiments are related to a processor of a user equipment (UE) configured to perform operations. The operations include receiving a configuration from a network for parameters including time and frequency resource parameters for a first bandwidth part (BWP) and frequency hopping (FH) parameters for determining time and frequency resource parameters for one or more FH BWPs from the first BWP, determining the time and frequency resource parameters for the one or more FH BWPs based in part on information included in the configuration from the network, the time and frequency resource parameters for the FH BWPs including at least a first physical resource block (PRB) offset between the first BWP and a first determined FH BWP, receiving a scheduling downlink control information (DCI) indicating the first BWP and a subset of the determined FH BWPs are activated for a first channel and performing uplink (UL) or downlink (DL) communications on the first channel in the activated first BWP and the determined one or more FH BWPs.

Other exemplary embodiments are related to a processor of a user equipment (UE) configured to perform operations. The operations include receiving a configuration from a network for parameters including time and frequency resource parameters for a first bandwidth part (BWP) and frequency hopping (FH) parameters for determining time and resource parameters for one or more FH BWPs from the first BWP, receiving a scheduling downlink control information (DCI) indicating the first BWP is activated for a first channel, receiving an indication that at least one of the one or more FH BWPs is activated, determining the time and resource parameters for the one or more activated FH BWPs by excluding the deactivated one or more FH BWPs based on information included in the configuration from the network and the scheduling DCI and performing uplink (UL) or downlink (DL) communications on the first channel in the activated first BWP and the determined one or more activated FH BWPs.

Still further exemplary embodiments are related toa processor of a user equipment (UE) configured to perform operations. The operations include receiving a configuration from a network for parameters including time and frequency resource parameters for a first bandwidth part (BWP) and frequency hopping (FH) parameters for determining time and frequency resource parameters for one or more FH BWPs from the first BWP, receiving a scheduling downlink control information (DCI) indicating the first BWP is activated for a first channel, determining the time and frequency resource parameters for the one or more FH BWPs based on information included in the network configuration and the scheduling DCI, the determined time and frequency resource parameters including an interval value for FH comprising a number of slots where a same RB location of the BWP is maintained and performing uplink (UL) or downlink (DL) communications on the first channel in the activated first BWP and the determined one or more FH BWPs.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an example illustrating the reduced bandwidth (5 MHz/11 PRBs) for enhanced reduced capability (eRedcap) user equipment (UEs) relative to the bandwidth (50 MHZ/270 PRBs) for some non-eRedcap UEs.

FIG. 5 shows a diagram for exemplary bandwidth part (BWP) based frequency hopping (FH) operations for downlink (DL) or uplink (UL) operations of an eRedcap user equipment (UE) according to various exemplary embodiments.

FIG. 6 shows a diagram for an exemplary sub-band-based bandwidth part (BWP) based frequency hopping (FH) operation for downlink (DL) or uplink (UL) operation of an eRedcap user equipment (UE) according to various exemplary embodiments.

FIG. 7a shows an exemplary MAC-CE for C-BWP or sub-band activation/deactivation according to various exemplary embodiments.

FIG. 7b shows an exemplary table for a two-bit FHI field description according to various exemplary embodiments.

FIG. 7c shows a diagram for C-BWP or sub-band activation/deactivation using the FHI field of FIG. 7b according to various exemplary embodiments.

FIG. 8 shows a diagram for an exemplary BWP-based frequency hopping (FH) operation with a FH interval enabled according to various exemplary embodiments.

FIG. 9 shows a method for bandwidth part (BWP) based frequency hopping (FH) operations for downlink (DL) or uplink (UL) operations of an eRedcap user equipment (UE) according to various exemplary embodiments.

### DETAILED DESCRIPTION

The exemplary embodiments may be further understood with reference to the following description and the related appended drawings, wherein like elements are provided with the same reference numerals. The exemplary embodiments introduce patterns and techniques for bandwidth part (BWP) based frequency hopping (FH) operations for enhanced reduced capability (eRedcap) user equipment (UEs). According to some exemplary embodiments, the network configuration of the BWP-based FH operations is described. In other exemplary embodiments, the activation/deactivation of the FH operations, including the activation/deactivation of frequency hopping for particular resource block (RB) regions and/or particular channels, is described.

The exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. The exemplary embodiments are further described with regard to enhanced reduced capability (eRedcap) UEs that have an operating bandwidth that is significantly reduced relative to other legacy UEs. However, the exemplary embodiments may be utilized with any UE operating under similar or different constraints and are not limited specifically to eRedcap UEs. Therefore, the UE as described herein is used to represent any electronic component that directly communicates with the network.

The exemplary embodiments are also described with regard to a 5G New Radio (NR) network. However, reference to a 5G NR network is merely provided for illustrative purposes. The exemplary embodiments may be utilized with any network implementing UDC methodologies similar to those described herein. Therefore, the 5G NR network as described herein may represent any type of network implementing similar UDC functionalities as the 5G NR network.

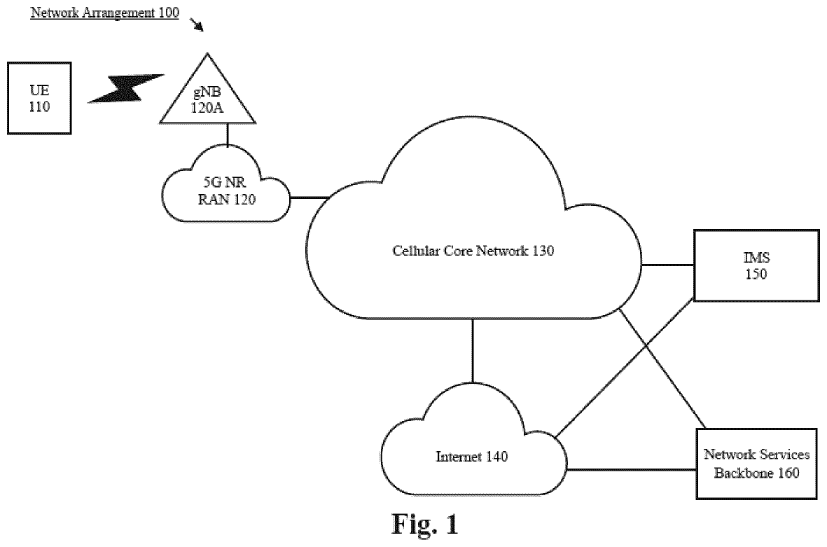

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop Computers, smartphones, phablets, embedded devices, wearables (e.g., HMD, AR glasses, etc.), Internet of Things (IoT) devices, Industrial IoT (IIot) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBS, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

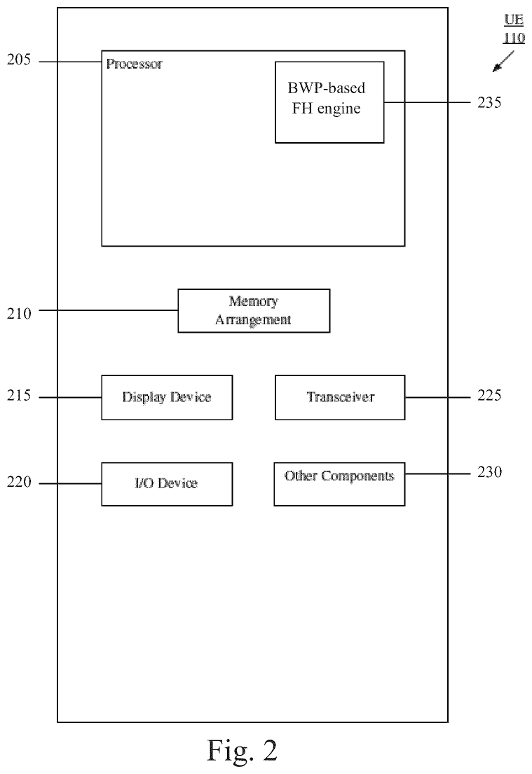

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110, For example, the engines may include a BWP-based frequency hopping engine 235 for performing various operations related to the BWP-based frequency hopping. These operations may include receiving parameters for a BWP configuration and additional parameters for determining the time and frequency locations of frequency hops to use when this BWP is activated. The operations may additionally include receiving one or more scheduling DCIs including parameters for activating the BWP for a downlink (DL) or uplink (UL) channel and additional parameters for performing the frequency hopping on the channel indicated in the scheduling DCI. The operations may additionally include determining the frequency hopping locations to use in the DL/UL operations based on the configured/indicated parameters received from the network. These operations will be explained in detail below.

The above referenced engine 235 being an application (e.g., a program) executed by the processor 205 is provided merely for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

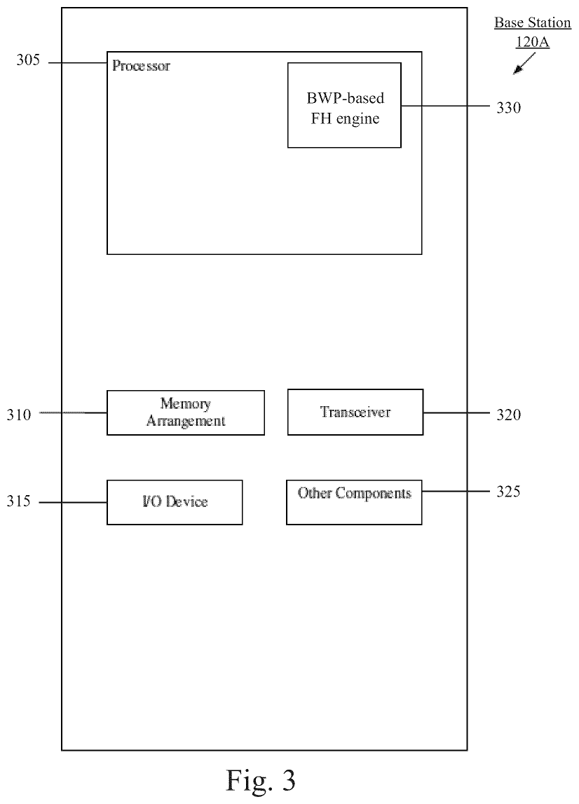

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a BWP-based frequency hopping engine 330 for performing various operations related to the BWP-based frequency hopping. These operations may include transmitting parameters for a BWP configuration and additional parameters for a UE to determine the time and frequency locations of frequency hops to use when the BWP is activated. The operations may additionally include transmitting one or more scheduling DCIs including parameters for activating the BWP for a downlink (DL) or uplink (UL) channel for the UE and additional parameters for performing the frequency hopping on the channel indicated in the scheduling DCI. The network, having knowledge of the frequency hopping locations used in the DL/UL operation, can schedule other channels for other UEs on the same component carrier so as to minimize interference between the signals. These operations will be explained in detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

A framework has been established for enabling reduced capability (Redcap) NR devices suitable for a range of use cases, including, e.g., industrial sensors, video surveillance, and wearables, with requirements on low UE complexity and, in some scenarios, low UE power consumption. Further reductions on complexity and cost for Redcap devices are desirable to further expand the market for Redcap use cases to provide relatively low cost, low energy consumption, and low data rate requirements for, e.g., industrial wireless sensor network use cases.

For Rel-18, the supported peak data rate for enhanced Redcap (eRedcap) devices targets to 10 Mbps. To further reduce complexity for eRedcap UEs, the UE bandwidth can be reduced to 5 MHz in FR1, the UE peak data rate in FR1 can be reduced, and the UE processing timeline for PDSCH and/or PUSCH and/or CSI can be relaxed.

Existing (non-Redcap) UEs typically operate with up to 270 PRBs with 15 kHz subcarrier spacing (SCS) (corresponding to a 50 MHz bandwidth) and up to 273 PRBs with 30 KHZ SCS (corresponding to a 100 MHZ bandwidth). As illustrated in Table 1, a 5 MHz bandwidth consists of 25 PRBs with 15 kHz SCS and 11 PRBs with 30 kHz SCS.

TABLE 1

| SCS | 5 MHZ | 10 MHz | 15 MHz | 20 MHz |
|---|---|---|---|---|
| (kHz) | N_{RB} | N_{RB} | N_{RB} | N_{RB} |
| 15 | 25 | 52 | 79 | 106 |
| 30 | 11 | 24 | 38 | 51 |

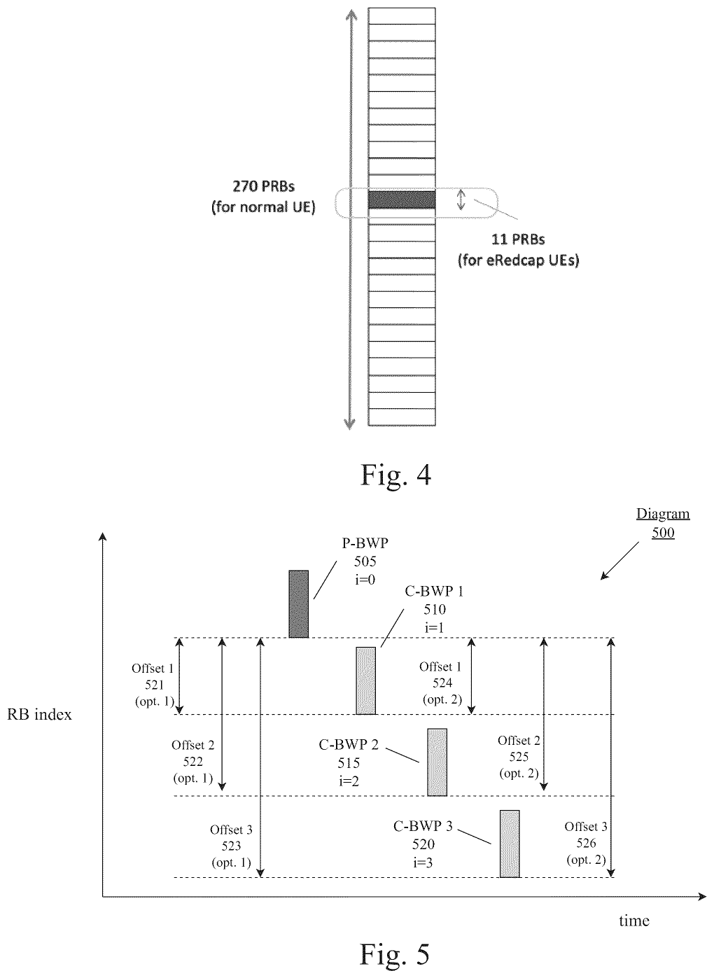

Compared to non-Redcap UEs operating with significantly higher bandwidths and a greater number of PRBs, the spectrum efficiency and throughput performance for eRedcap UEs operating with a reduced 5 MHz bandwidth (and a lesser number of PRBs) could be significantly degraded due to a lack of frequency diversity gain. FIG. 4 shows an example illustrating the reduced bandwidth (5 MHz/11 PRBs) for enhanced reduced capability (eRedcap) user equipment (UEs) relative to the bandwidth (50 MHz/270 PRBs) for some non-eRedcap UEs. For channels within this active bandwidth part (BWP) of 11 PRBs, the lack of frequency diversity across the reduced BWP can cause significant performance degradation.

A carrier bandwidth part (BWP) refers to a contiguous set of physical resource blocks (PRBs) selected from a contiguous subset of the common resource blocks for a given numerology on a given carrier. A maximum of four BWPs can be configured for downlink (DL) or uplink (UL), wherein one of the configured BWPs can be active for DL or UL at a given time. The network can activate/deactivate a BWP using a scheduling downlink control information (DCI).

Frequency hopping (FH) refers to a technique to spread radio signals across several frequency channels. Within a component carrier (CC), the transmitter can hop between narrowband frequencies several times per second in a pseudo-random sequence known to the transmitter and the receiver. FH can provide benefits such as resistance to interference and increase in frequency diversity gain. Since Rel-15, NR supports frequency hopping (FH) or frequency scheduling (FS) operation for DL/UL channels limited to within an active BWP. The network can configure frequency hopping in the BWP configuration.

According to various exemplary embodiments described herein, eRedcap UEs can be configured for DL/UL operations with frequency hopping enabled to obtain meaningful frequency diversity gain in view of the narrow bandwidth (e.g., limited to a maximum of 11 RBs in an active BWP in case of 5 MHz bandwidth and 30 kHz SCS). The frequency hopping patterns can be designed to ensure efficient coexistence of eRedcap UEs and other UEs (normal UEs and/or Rel-17 Redcap UEs) by avoiding resource fragmentation and collision. In addition, the BWP switching framework for frequency hopping can be modified. The existing BWP switching framework for frequency hopping would cause unacceptable latency and throughput loss for eRedcap UEs as described above.

A variety of approaches may be considered to support a floating BWP for narrowband (NB) eRedcap UEs to leverage the frequency diversity gain over a wider CC bandwidth.

In one aspect of these exemplary embodiments, the configuration of the BWP-based frequency hopping operation is described. Hereinafter, the BWP configured directly by RRC signaling (including, e.g., a time domain and frequency domain resource allocation) may be referred to as a Parent BWP (P-BWP) and the BWP(s) created from the P-BWP with frequency hopping may be referred to as a Child BWP (C-BWP), The C-BWP may also be referred to as a FH BWP. The time and frequency resources for one or more P-BWPs can be configured by the network, and the UE can determine the locations of the C-BWP(s) based on one or more parameters as described below.

In some exemplary embodiments, the C-BWPs can be defined based on one or more RB offset values newly introduced for a DL or UL BWP configuration. In other exemplary embodiments, the C-BWPs can be defined by a sub-band-based approach where the component carrier (CC) is divided into a set of sub-bands and each sub-band can potentially include a C-BWP therewithin.

According to the first exemplary embodiments described above for configuring BWP-based FH operation, the network can configure a P-BWP that occupies a certain frequency range (RB range), where the C-BWP(s) are defined based on an RB offset. In one option, the RB offset for each C-BWP with hopping index i is defined relative to the P-BWP with hopping index i=0. In another option, the RB offset for a C-BWP with hopping index i is defined relative to the BWP with hopping index i−1, which can be the P-BWP or a C-BWP.

FIG. 5 shows a diagram 500 for exemplary bandwidth part (BWP) based frequency hopping (FH) operations for downlink (DL) or uplink (UL) operations of an eRedcap user equipment (UE) according to various exemplary embodiments. The diagram 500 includes a P-BWP 505 configured by the network and three frequency hops comprising C-BWPs, e.g., C-BWP 510, C-BWP 515 and C-BWP 520, defined using an RB offset value RB_{offset,i}, to be described in detail below. Although three C-BWPs 510-520 are shown in the diagram 500, those skilled in the art will understand that more or less frequency hops can be configured/used in the DL/UL operations depending on factors such as the total bandwidth of the component carrier (CC), the bandwidth of each BWP, coexistence with other channels used by other UEs, etc. Additionally, the BWPs 505-520 shown in the exemplary diagram 500 have an interval of one slot, however, an interval comprising a greater number of slots can be used. These aspects will be described in greater detail below.

According to the first option, the RB offset RB_{offset,i} for a C-BWP with hopping index i may be defined from an RB index of the P-BWP with hopping index i=0. In one example, the offset value RB_{offset,i} for a C-BWP with hopping index i, i>1 can be determined as follows, where i=0 is used for the P-BWP: RB_{offset,i}=(i*Δ), Δ>N_{P-BWP}, where Δ is configured by RRC signaling and N_{P-BWP} is the number of RBs configured for the P-BWP. The RB offset RB_{offset,i} for the C-BWP i may be defined from, for example, the smallest or largest RB index of the P-BWP. Those skilled in the art will ascertain that the RB offset can be defined relative to any RB index occupied by the P-BWP.

In the second option, the RB offset RB_{offset,i} for a C-BWP with hopping index i may be defined relative to an immediately previous BWP with hopping index i−1. The BWP i−1 can be a C-BWP or the P-BWP. In one example, the offset value RB_{offset,i} for a C-BWP with hopping index i, i>1 can be a single value RB_{offset,i}=RB_{offset} that can be configured by RRC signaling and applied for each C-BWP. In some designs, i=1, i.e., limiting the operations to two hops for a BWP or i=0, e.g., no hopping for a BWP. Similar to the first option, the RB_{offset,i} for the C-BWP i may be defined from any RB index of the BWP i−1, for example, the smallest or largest RB index of the BWP i−1.

In the exemplary diagram 500 of FIG. 5, the P-BWP 505 has hopping index i=0, the C-BWP 510 has hopping index i=1, the C-BWP 515 has hopping index i=2, and the C-BWP 520 has hopping index i=3. For the first option described above, the RB offset for the C-BWPs is defined relative to the P-BWP. In this example, the RB offset is defined from the smallest RB index of the P-BWP, as shown for the RB_{offset,1} 521 for C-BWP 510 with hopping index i=1, the RB_{offset,2} 522 for C-BWP 515 with hopping index i=2, and the RB_{offset,3} 523 for C-BWP 520 with hopping index i=3. For the second option described above, the RB offset for the C-BWP i is defined relative to the BWP i−1. In this example, the RB offset is defined from the smallest RB index of the P-BWP, as shown for the RB_{offset,1} 524 for C-BWP 510 with hopping index i=1, the RB_{offset,2} 525 for C-BWP 515 with hopping index i=2, and the RB_{offset,3} 526 for C-BWP 520 with hopping index i=3.

According to the second type of exemplary embodiments for configuring BWP-based FH operation described above, the network can configure a P-BWP that occupies a first sub-band having a configurable or determinable size (expressed in units of RBs), wherein the whole bandwidth of the component carrier (CC) is divided into a set of sub-bands. The C-BWP(s) are defined for a particular one of the set of sub-bands different from the P-BWP.

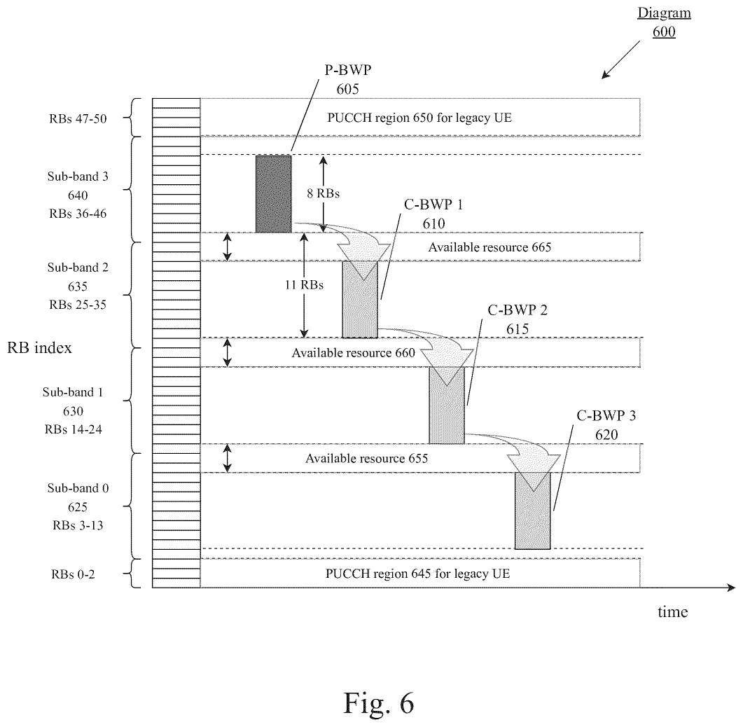

The number of sub-bands in the set N_{subband} can be defined as flooring(N_{CC}^{size}/N_{subband}^{size}), wherein N_{CC}^{size} represents the CC bandwidth configuration in units of RBs and N_{subband}^{size} represents the number of RBs in each sub-band. To provide an example, to be described in further detail below with respect to FIG. 6, a 20 MHz CC having a 30 kHz SCS has a CC bandwidth N_{CC}^{size}=51 PRBs; the number of RBs per sub-band N_{subband}^{size}=11 PRBs; and N_{subband}=flooring(N_{CC}^{size}/N_{subband}^{size})=4 sub-bands.

A variety of approaches may be considered to determine the size of sub-band N_{subband}^{size}. In a first option, the value of N_{subband}^{size} can be hard-encoded in specifications (e.g., the 3GPP Specifications). For example, in one design, N_{subband}^{size} Can equal the maximum supported bandwidth of the UE (e.g., Rel-18 eRedCap UE) based on subcarrier spacing μ. For 30 kHz SCS, N_{subband}^{size} can be 10 or 11 PRBs, and for 15 kHz SCS, N_{subband}^{size} can be 24 or 25 PRBS. In a second option, the value of N_{subband}^{size} can be a function of the downlink CC bandwidth N_{CC}^{size}. The value of N_{subband}^{size} can vary across DL CC BW sizes depending on a tradeoff between frequency diversity gain (which can be beneficially increased for a larger sub-band size and thus larger frequency offsets between the frequency hops) and switching gap overhead (which can be beneficially decreased for smaller sub-band size and smaller frequency offsets between the frequency hops). In a third option, a set of candidate values may be hard-encoded in specification and one value from the set can be signaled by the network in a System Information Block (SIB) e.g., SIB1.

In one aspect, a starting RB can be configured by the network to ensure co-existence with legacy UEs operating with a wider bandwidth. The starting PRB of the lowest sub-band may be configured by the gNB to, e.g., avoid collision with the PUCCH resources region reserved for the initial access procedure of legacy UEs (including, e.g., Rel-17 Redcap UEs), as will be shown in the example of FIG. 6 below.

FIG. 6 shows a diagram 600 for an exemplary sub-band-based bandwidth part (BWP) based frequency hopping (FH) operation for downlink (DL) or uplink (UL) operation of an eRedcap user equipment (UE) according to various exemplary embodiments. The diagram 600 includes a P-BWP 605 configured by the network and three frequency hops comprising C-BWPs, e.g., C-BWP 610, C-BWP 615 and C-BWP 620, similar to FIG. 5 described above. In exemplary diagram 600, according to the second embodiment for configuring BWP-based FH operation discussed above, the BWPs 605-620 are defined using a sub-band-based approach.

In the example of FIG. 6, the UE is configured with a 20 MHz CC having a 30 kHz SCS, corresponding to a CC bandwidth N_{CC}^{size}=51 PRBs, e.g., RBs 0-50. The UE is further configured with, or determines based on specification, the number of RBs per sub-band N_{subband}^{size}=11 PRBs. With these parameters, the N_{subband}=flooring(N_{CC}^{size}/N_{subband}^{size}) can be calculated as N_{subband}=4 sub-bands. Thus, the BWPs can be located in any one of four frequency hops within a first sub-band 625 (sub-band 0), a second sub-band 630 (sub-band 1), a third sub-band 635 (sub-band 2) or a fourth sub-band 640 (sub-band 3), wherein sub-bands 0-3 are located in frequency in ascending order of RB. In the example of FIG. 6, the P-BWP 605 is configured in the fourth sub-band 640 (sub-band 3), which has a highest RB range, wherein C-BWPs 610-625 are located in the first, second and third sub-bands 625-635 (sub-bands 0-2). In other words, the frequency hops proceed in time in descending order of frequency. However, those skilled in the art will understand that the frequency hops can proceed in time in ascending order of frequency, where the P-BWP is configured in a sub-band having a lowest RB range relative to the other sub-bands in the set. In still other embodiments, a P-BWP can be configured in a sub-band having an RB range somewhere in the middle of the set.

In this example, the CC includes resources for legacy UEs on the edges of the CC bandwidth. The RBs 0-2 are reserved for a first PUCCH region 645 for legacy UEs and the RBs 47-50 are reserved for a second PUCCH region 650 for legacy UEs. The network (e.g., gNB) can configure the starting PRB of the lowest sub-band so that the frequency hops for the eRedcap UE will not collide with the PUCCH regions 645, 650 for legacy UEs. In this example, the starting PRB is configured to be RB 3. Therefore, sub-band 0 625 comprises RBs 3-13, sub-band 1 630 comprises RBs 14-24, sub-band 2 635 comprises RBs 25-35, and sub-band 3 640 comprises RBs 36-46.

The P-BWP 605 is configured to span 8 RBs (RBs 37-44) in sub-band 3 640. The frequency hops are spread across sub-bands 0-2 625-635 and each span 8 RBs. C-BWP 1 610 is configured in RBs 26-33 in sub-band 2 635. C-BWP 2 615 is configured in RBs 15-22 in sub-band 1 630. C-BWP 3 620 is configured in RBs 4-11 in sub-band 0 625. The BWPs 605-620 are offset by 11 RBs, corresponding to the length of each sub-band 625-640 and, as described above, each span 8 RBs. Thus, a region of 3 RBs exists between two consecutive BWPs with frequency hopping. These regions, e.g., available resources 655 between C-BWP 2 615 and C-BWP 3 620 (RBs 12-14), available resource 660 between C-BWP 1 610 and C-BWP 2 615 (RBs 13-15), and available resources 665 between the P-BWP 605 and C-BWP 1 610 (RBs 34-36), can be used by the network for other purposes, including as a PUCCH resource for legacy UEs or for other channels. The lowest RB for C-BWP 3 620 is RB 4, and the highest RB for the P-BWP 605 is RB 45, therefore RB 3 and RBs 46-47 are also available to the network for other purposes. The available RBs that are not being used for eRedcap frequency hopping can be leveraged by the network to semi-statically allocate PUCCH resources for legacy devices and therefore avoid be impacted by BWP hopping of the eRedcap UE.

According to certain aspects of this disclosure, a variety of options may be considered to determine which BWPs (configured according to the first embodiment) or sub-bands (configured according to the second embodiment) are used for BWP frequency hopping out of the set of available BWPs/sub-bands.

In a first option, the BWP frequency hopping is performed across all of the RRCconfigured C-BWPs (first embodiment) or sub-bands (second embodiment) in increasing order of C-BWP index or sub-band index. For the second embodiment (sub-band-based), the frequency offset in RBs between two frequency hops of a given BWP can be equal to the N_{subband}^{size}, as shown in FIG. 6. The first option is simple from specification perspective. However, it increases the gNB scheduler complexity significantly to avoid resource collision between narrowband eRedcap UEs with FH and wide-band normal UEs in a same serving cell.

In a second option, a new MAC Control Element (CE) is introduced to activate and deactivate RRC-configured C-BWPs or sub-bands to, e.g., avoid overlapping a BWP with RBs used by legacy UEs. The new MAC CE can have a fixed size of one octet and be identified by a MAC sub-header with a dedicated LCID.

The C-BWPs or sub-band activation/deactivation MAC-CE may be defined as follows. A field Cᵢ can be used to indicate the activation/deactivation status of the iₜₕ C-BWP or sub-band. The field can be set to 1 to indicate the corresponding BWP to be activated and can be set to 0 to indicate the corresponding BWP to be deactivated. A field R for Reserved bits, set to 0, can be used in the fields of the octet that are not used for a Cᵢ field.

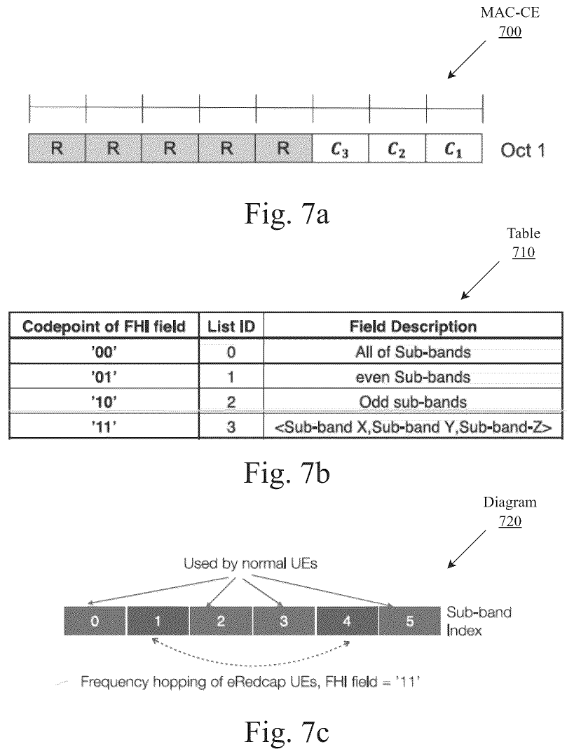

FIG. 7a shows an exemplary MAC-CE 700 for C-BWP or sub-band activation/deactivation according to various exemplary embodiments. In this example, three C-BWPs or four sub-bands are configured via RRC. Accordingly, 3 bits of the octet are used for Cᵢ fields for activation/deactivation, e.g., C₁, C₂, and C₃, and 5 bits of the octet are reserved R. The frequency hopping is conducted across all of the activated C-BWPs or Sub-bands.

In a third option, the C-BWP(s) (first embodiment) or sub-band(s) (second embodiment) used for frequency hopping may be indicated by the scheduling DCI. This option may be used for dynamic-grant PDSCH/PUSCH. In one variant, for eRedcap UEs, a new bitmap field can be added into a scheduling DCI, where each bit is used to indicate the activation/deactivation status of a corresponding C-BWP or Sub-band. In another variant, a two-step approach can be used. In the first step, a set of C-BWP lists or sub-band lists are first configured by RRC signaling or hard-encoded in specification (e.g., for transmission/receptions in RRC IDLE mode). A C-BWP list or sub-band list may include one or multiple C-BWPs or sub-bands and is associated with a dedicated list ID. In the second step, a list ID may be provided by a dedicated ‘frequency hopping indicator’ (FHI) field in scheduling DCI, where the bit width of the field may be determined based on the number of lists for a given signal or channels.

FIG. 7b shows an exemplary table 710 for a two-bit FHI field description according to various exemplary embodiments. As shown, the codepoint ‘00’ of the FHI field can indicate list ID 0, the codepoint ‘01’ of the FHI field can indicate list ID 1, the codepoint ‘10’ of the FHI field can indicate list ID 2, and the codepoint ‘11’ of the FHI field can indicate list ID 3. List ID 0 can comprise all sub-bands, list ID 1 can comprise all even sub-bands, list ID 2 can comprise all odd sub-bands, and list ID 3 can comprise any custom selection of sub-bands, e.g., sub-band X, sub-band Y, sub-band Z, etc.

FIG. 7c shows a diagram 720 for C-BWP or sub-band activation/deactivation using the FHI field of FIG. 7b according to various exemplary embodiments. In this example, six sub-bands/BWPs are first determined or configured based on the CC bandwidth. The gNB may indicate codepoint ‘11’ of the FHI field in the scheduling DCI to limit the frequency hopping of eRedcap within the union of sub-bands X and Y, e.g., of sub-band 1 and sub-band 4 of the six sub-bands, such that the legacy UEs can be scheduled within leftover sub-bands 0, 2, 3 and 5 without impacts by eRedcap hopping.

According to certain aspects of this disclosure, an interval of BWP frequency hopping may be introduced for eRedcap UEs. When the FH is enabled for a given BWP, the same RB locations of the BWP can be maintained for a certain number of Nₛ slots, referred to herein as the ‘FH interval’ and the frequency location of the BWP is switched every Nₛ slots. The FH interval can be increased to enable cross-slot channel estimation. A same precoding can be applied to the scheduled PDSCHs or PUSCHs associated with a same TCI State or a same QCL assumption.

In some designs, a set of Nₛ values may be hard-encoded in specification and used for different UEs or different DL/UL channels for a given UE. In one example, Nₛ={1,2,4,8}.

FIG. 8 shows a diagram 800 for an exemplary BWP-based frequency hopping (FH) operation with a FH interval enabled according to various exemplary embodiments. In this example, the FH interval Nₛ=2 and two sub-bands are configured. A BWP 805 on sub-band X comprises two slots and a BWP 810 on sub-band Y comprises two slots.

The gNB is given flexibility to control the interval for particular UEs based on various network considerations, such as, e.g., the speed at which the UE is traveling. For low-mobility UEs, a greater interval (more slots) can improve performance while for high-mobility UEs, a lesser interval (fewer slots) can be beneficial. The FH interval Nₛ slots can be configured in a variety of ways.

In a first option, one value may be selected by the network and provided in a cell-specific manner to minimize the signal overhead needed to configure this parameter. In some designs, the selected Nₛ value may be provided in SIB for all eRedcap UEs.

Additionally, for the first option, the network can override the broadcasted Nₛ value for particular UEs. For example, the Nₛ value may be configured (e.g., enabled/disabled) via dedicated RRC signaling for UE-specific BWP or some UE-specific channels.

In a second option, the FH interval Nₛ slots may be configured on a per-BWP basis for UE-dedicated BWPs. For receiving SIB1 transmissions, the Nₛ value to use may be provided through the scheduling DCI for the PDSCH. For example, two reserved bits may be repurposed to indicate one from four hard-encoded values for FH interval Nₛ slots used for receiving the SIB transmissions for eRedcap-specific SIB. For other messages in the initial access procedure, e.g., Msg2/Msg3/Msg4, at least two variants can be considered. In one variant, similar to above, two reserved bits in the scheduling DCI may be used to provide the Nₛ slots. In another variant, the SIB1 can carry the Ng value.

In a third option, as a unified solution, the value of the FH interval Nₛ slots may be signaled by a field in the scheduling DCI, e.g., by repurposing the reserved bits in the scheduling DCI or introducing a new field to implement this function. For Nₛ=1, the UE may be additionally provided the enabling/disabling intra-slot FH.

The frequency hopping operation may be explicitly disabled by the higher layers for a cell (e.g., SIB1), for a UE or a UE-dedicated BWP (e.g., UE-dedicated RRC signaling) or by a dedicated value of corresponding field in scheduling DCI for a given signal/channels (e.g., all zeros or all ones),

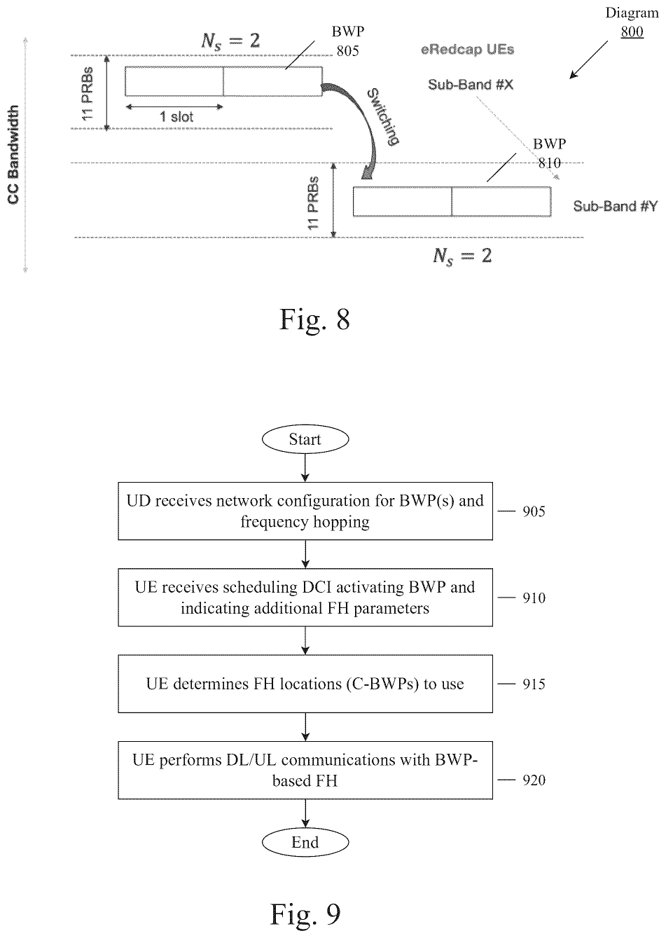

FIG. 9 shows a method 900 for bandwidth part (BWP) based frequency hopping (FH) operations for downlink (DL) or uplink (UL) operations of an eRedcap user equipment (UE) according to various exemplary embodiments.

In 905, the UE receives a BWP and frequency hopping configuration from the network. The BWP configuration can include time and frequency parameters for one or more BWPs that can be activated by the network and used for network operations (UL or DL). In all cases, the BWP configuration at least includes the time and frequency resources for the BWP, a subcarrier spacing (SCS), and other parameters known to those skilled in the art. According to the various embodiments discussed above, various additional parameters can be included in the BWP/FH configuration to support the BWP-based frequency hopping operation. These additional parameters allow the UE to determine the time and frequency resources for the C-BWPs created by the P-BWP with frequency hopping.

For example, according to the first exemplary embodiment for configuring the BWP-based FH discussed above with respect to FIG. 5, the UE can receive a parameter for determining an RB offset RB_{offset,i} for a C-BWP with hopping index i, i>1 (parameter Δ in one option (where the C-BWPs are defined relative to the P-BWP) and parameter RB_{offset} in another option (where the C-BWPs i defined relative to BWP i−1)).

In another example, according to the second exemplary embodiment for configuring the BWP-based FH discussed above with respect to FIG. 6, the UE can receive a parameter for determining the sub-band size N_{subband}^{size} (e.g., a value from a set of hard-encoded values signaled in SIB1). In other embodiments, the UE can determine this parameter, as shown below in step 905. Additionally, the UE can receive a configuration for a starting PRB to be used for the lowest sub-band in the set of sub-bands spanning the component carrier. The network can select the starting PRB based on scheduling constraints for other (e.g., legacy) UEs, e.g., the PUCCH region for legacy UEs on the edges of the CC.

In still another example, the UE can receive a configuration of a C-BWP list or sub-band list including one or multiple C-BWPs or sub-bands associated with a list ID. Based on the list ID indicated in the scheduling DCI, the UE can activate/deactivate particular C-BWPs/sub-bands for the FH operation. The network can select to activate/deactivate certain C-BWPs/sub-bands based on scheduling constraints for other (e.g., legacy) UEs.

In still another example, the UE can receive a configuration for a frequency hopping interval Nₛ slots. In one embodiment, the Nₛ value can be provided in a system information (SI) broadcast (e.g., SIB1). In other embodiments, the Nₛ value can be provided in dedicated RRC signaling.

In still another example, the FH operation can be explicitly disabled via SIB1 or UE-dedicated RRC signaling.

In 910, the UE receives a scheduling DCI including an activation of a particular one of the configured BWPs and, in some embodiments, additional parameters for performing the BWP-based frequency hopping.

For example, in one embodiment, the scheduling DCI can indicate the activation/deactivation status of a corresponding C-BWP or sub-band. In a variant, a list ID can be indicated in the scheduling DCI corresponding to one from a configured list of activation/deactivation patterns.

In another example, the UE can receive an indication for a frequency hopping interval Nₛ slots. In one embodiment, the Nₛ value can be provided as two reserved bits in the scheduling DCI or introducing a new field in the scheduling DCI.

In still another example, the FH operation can be explicitly disabled via scheduling DCI.

In 915, the UE determines the frequency hopping locations (C-BWPs) to be used based on the parameters received from the network and/or hard-encoded parameters.

For example, according to the first exemplary embodiment for configuring the BWP-based FH discussed above with respect to FIG. 5, as an initial step, the UE can determine the PRBs for the configured P-BWP and the offset value RB_{offset,i} for a C-BWP with hopping index i relative to the P-BWP or the BWP i−1. The RB_{offset,i} can be defined, e.g., relative to a smallest or largest RB index of the P-BWP. The UE can determine the RB offset for each of the C-BWPs based on the received parameter for determining the RB offset (parameter Δ in one option and parameter RB_{offset} in another option).

In another example, according to the second exemplary embodiment for configuring the BWP-based FH discussed above with respect to FIG. 6, as an initial step, the UE can determine a set of sub-bands from the bandwidth of the component carrier (CC). The number of sub-bands in the set N_{subband} Can be determined from the total number of PRBs in the CC bandwidth and the number of PRBs per sub-band. The sub-band size can be hard-encoded in specification (first option), can be a function of the CC bandwidth, and/or can be indicated by the network, e.g., in SIB1, and selected from a set of hard-encoded values. In still another example, the UE can determine a starting PRB of the lowest sub-band from a network configuration. The frequency offset in RBs between two frequency hops can be determined as equal to the sub-band size.

In still another example, the UE can determine which C-BWPs or sub-bands to use (activate/deactivate the C-BWPs) for the FH operations. In one option, all of the BWPs configured by the network are used by default. In another option, the UE can determine whether to activate/deactivate the respective C-BWPs or sub-bands based on a received MAC-CE. In still another option, for, e.g., a dynamic grant PDSCH/PUSCH, the scheduling DCI can indicate the activation/deactivation status of a corresponding C-BWP or sub-band (in one embodiment, based on a configuration of a C-BWP list or sub-band list and the list ID indicated in the scheduling DCI).

In still another example, the UE can determine the interval to use for FH. A set of interval values can be hard-encoded in specification and depend on the type of channel activated for the P-BWP. An interval value can be indicated from the set in a SIB broadcast, RRC signaling, or a scheduling DCI.

In 920, performing UL/DL communications in accordance with the determined FH locations.

Those skilled in the art will understand that the configuration steps described in 905, the activation steps described in 910, the determination steps described in 915, and the performing UL/DL communications step in 920 can be performed in various orders of operation. For example, the UE can perform frequency hopping in accordance with a first BWP and FH configuration and parameters indicated in a first one or more scheduling DCI, whereafter the UE may receive different BWP and FH configuration parameters prior to performing frequency hopping for subsequent UL/DL operations, e.g., UL/DL operations on different channels. In another example, the FH parameters for a BWP for receiving SIB1 can be received in a scheduling DCI and changed for subsequent initial access operations (Msg2/Msg3/Msg4) using SIB1 or another scheduling DCI.

As discussed above, the FH operation can be explicitly disabled via SIB1, UE-dedicated RRC signaling, or scheduling DCI.

### EXAMPLES

In a first example, a processor of a user equipment (UE) is configured to perform operations comprising receiving a configuration from a network for parameters including time and frequency resource parameters for a first bandwidth part (BWP) and frequency hopping (FH) parameters for determining time and frequency resource parameters for one or more FH BWPs from the first BWP, determining the time and frequency resource parameters for the one or more FH BWPs based in part on information included in the configuration from the network, the time and frequency resource parameters for the FH BWPs including at least a first physical resource block (PRB) offset between the first BWP and a first determined FH BWP, receiving a scheduling downlink control information (DCI) indicating the first BWP and a subset of the determined FH BWPs are activated for a first channel and performing uplink (UL) or downlink (DL) communications on the first channel in the activated first BWP and the determined one or more FH BWPs.

In a second example, the processor of the first example, wherein the first PRB offset is defined relative to a smallest or largest RB index of the first BWP and configured via radio resource control (RRC) signaling.

In a third example, the processor of the second example, wherein the time and frequency resource parameters for the FH BWPs include a set of PRB offset values for each of the one or more FH BWPs.

In a fourth example, the processor of the first example, wherein first BWP is configured in a component carrier, wherein the operations further comprise dividing the component carrier into a number of sub-bands based on a size of the component carrier and a size of the sub-bands expressed in units of PRBs, wherein the first BWP is carried in a first sub-band and each of the one or more FH BWPs is carried in a respective further sub-band.

In a fifth example, the processor of the fourth example, wherein the size of the sub-bands is a value hard-encoded in specification.

In a sixth example, the processor of the fifth example, wherein the size of the sub-bands equals a total bandwidth of the UE in units of PRBs based on a subcarrier spacing (SCS) for the component carrier.

In a seventh example, the processor of the sixth example, wherein the size of the sub-bands equals 11 or 10 PRBs for 30 KHz SCS and the size of the sub-bands equals 24 or 25 PRBs for 15 KHz SCS.

In an eighth example, the processor of the fifth example, wherein the size of the sub-bands is a function of the size of the component carrier or a bandwidth of the component carrier.

In a ninth example, the processor of the fourth example, wherein the network configuration further includes a set of candidate values for the size of the sub-bands, wherein the operations further comprise receiving an indication of one of the set of candidate values.

In a tenth example, the processor of the fourth example, wherein the network configuration further includes a starting PRB of one of the sub-bands having a lowest RB index.

In an eleventh example, the processor of the tenth example, wherein the starting PRB and the frequency resource locations of the first BWP and the one or more FH BWPs are selected for co-existence with channels of other UEs located in the same component carrier.

In a twelfth example, the processor of the eleventh example, wherein the channels of the other UEs include a physical uplink control channel (PUCCH) resources region reserved for an initial access procedure.

In a thirteenth example, a user equipment (UE) comprises a transceiver configured to communicate with a network and a processor communicatively coupled to the transceiver and configured to perform operations comprising receiving a configuration from the network for parameters including time and frequency resource parameters for a first bandwidth part (BWP) and frequency hopping (FH) parameters for determining time and frequency resource parameters for one or more FH BWPs from the first BWP, determining the time and frequency resource parameters for the one or more FH BWPs based in part on information included in the configuration from the network, the time and frequency resource parameters for the FH BWPs including at least a first physical resource block (PRB) offset between the first BWP and a first determined FH BWP, receiving a scheduling downlink control information (DCI) indicating the first BWP and a subset of the determined FH BWPs are activated for a first channel and performing uplink (UL) or downlink (DL) communications on the first channel in the activated first BWP and the determined one or more FH BWPs.

In a fourteenth example, a processor of a base station is configured to perform operations comprising transmitting a network configuration for parameters including time and resource parameters for a first bandwidth part (BWP) and frequency hopping (FH) parameters for a user equipment (UE) to determine time and resource parameters for one or more FH BWPs from the first BWP, transmitting time and resource parameters for the one or more FH BWPs based on information included in the network configuration, the time and frequency resource parameters for the FH BWPs including at least a first physical resource block (PRB) offset between the first BWP and a first determined FH BWP, transmitting a scheduling downlink control information (DCI) indicating the first BWP and a subset of the FH BWPs are activated for a first channel and performing uplink (UL) or downlink (DL) communications on the first channel in the activated first BWP and the determined one or more FH BWPs.

In a fifteenth example, the processor of the fourteenth example, wherein the first PRB offset is defined relative to a smallest or largest RB index of the first BWP and configured via radio resource control (RRC) signaling.

In a sixteenth example, the processor of the fifteenth example, wherein a second PRB offset is determined between a smallest PRB or a largest RB index of the first BWP and a smallest PRB or a largest RB index of a second determined FH BWP.

In a seventeenth example, the processor of the fifteenth example, wherein a second PRB offset is determined between a smallest PRB or a largest RB index of the first determined FH BWP and a smallest PRB or a largest RB index of a second determined FH BWP.

In an eighteenth example, the processor of the fifteenth example, wherein the time and frequency resource parameters for the FH BWPs include a set of PRB offset values for each of the one or more FH BWPs.

In a nineteenth example, the processor of the fourteenth example, wherein first BWP is configured in a component carrier, wherein the operations further comprise dividing the component carrier into a number of sub-bands based on a size of the component carrier and a size of the sub-bands expressed in units of PRBs, wherein the first BWP is carried in a first sub-band and each of the one or more FH BWPs is carried in a respective further sub-band.

In a twentieth example, the processor of the nineteenth example, wherein the size of the sub-bands is a value hard-encoded in specification.

In a twenty first example, the processor of the twentieth example, wherein the size of the sub-bands equals a total bandwidth of the UE in units of PRBs based on a subcarrier spacing (SCS) for the component carrier.

In a twenty second example, the processor of the twenty first example, wherein the size of the sub-bands equals 11 or 10 PRBs for 30 KHz SCS and the size of the sub-bands equals 24 or 25 PRBs for 15 KHz SCS.

In a twenty third example, the processor of the twentieth example, wherein the size of the sub-bands is a function of the size of the component carrier or a bandwidth of the component carrier.

In a twenty fourth example, the processor of the nineteenth example, wherein the network configuration further includes a set of candidate values for the size of the sub-bands, wherein the operations further comprise transmitting an indication of one of the set of candidate values.

In a twenty fifth example, the processor of the twenty fourth example, wherein the indication of one of the set of candidate values is transmitted in a system information block 1 (SIB1).

In a twenty sixth example, the processor of the nineteenth example, wherein the network configuration further includes a starting PRB of one of the sub-bands having a lowest RB index.

In a twenty seventh example, the processor of the twenty sixth example, wherein the starting PRB and the frequency resource locations of the first BWP and the one or more FH BWPs are selected for co-existence with channels of other UEs located in the same component carrier.

In a twenty eighth example, the processor of the twenty seventh example, wherein the channels of the other UEs include a physical uplink control channel (PUCCH) resources region reserved for an initial access procedure.

In a twenty ninth example, a base station comprises a transceiver configured to communicate with a user equipment (UE) and a processor communicatively coupled to the transceiver and configured to perform operations comprising transmitting a network configuration for parameters including time and resource parameters for a first bandwidth part (BWP) and frequency hopping (FH) parameters for a user equipment (UE) to determine time and resource parameters for one or more FH BWPs from the first BWP, transmitting time and resource parameters for the one or more FH BWPs based on information included in the network configuration, the time and frequency resource parameters for the FH BWPs including at least a first physical resource block (PRB) offset between the first BWP and a first determined FH BWP, transmitting a scheduling downlink control information (DCI) indicating the first BWP and a subset of the FH BWPs are activated for a first channel and performing uplink (UL) or downlink (DL) communications on the first channel in the activated first BWP and the determined one or more FH BWPs.

In a thirtieth example, a processor of a user equipment (UE) is configured to perform operations comprising receiving a configuration from network for parameters including time and frequency resource parameters for a first bandwidth part (BWP) and frequency hopping (FH) parameters for determining time and resource parameters for one or more FH BWPs from the first BWP, receiving a scheduling downlink control information (DCI) indicating the first BWP is activated for a first channel, receiving an indication that at least one of the one or more FH BWPs is activated, determining the time and resource parameters for the one or more activated FH BWPs by excluding the deactivated one or more FH BWPs based on information included in the configuration from the network and the scheduling DCI and performing uplink (UL) or downlink (DL) communications on the first channel in the activated first BWP and the determined one or more activated FH BWPs.

In a thirty first example, the processor of the thirtieth example, wherein the indication is carried in the scheduling DCI.

In a thirty second example, the processor of the thirty first example, wherein the configuration from the network further includes a set of FH BWP or sub-band lists for activating or deactivating and the indication selects one entry from the set of PH BWP or sub-band lists.

In a thirty third example, the processor of the thirty second example, wherein the indication is provided by a dedicated frequency hopping indicator (FHI) field in the scheduling DCI.

In a thirty fourth example, the processor of the thirty third example, wherein the FHI field indicates an index of the FH BWP or sub-band list pattern to use for activating the one or more FH BWPs for communication with the network.

In a thirty fifth example, the processor of the thirtieth example, wherein the one or more FH BWPs are selected for activation for co-existence with channels of other UEs located in the same component carrier.

In a thirty sixth example, a user equipment (UE) comprises a transceiver configured to communicate with a network and a processor communicatively coupled to the transceiver and configured to perform operations comprising receiving a configuration from network for parameters including time and frequency resource parameters for a first bandwidth part (BWP) and frequency hopping (FH) parameters for determining time and resource parameters for one or more FH BWPs from the first BWP, receiving a scheduling downlink control information (DCI) indicating the first BWP is activated for a first channel, receiving an indication that at least one of the one or more FH BWPs is activated, determining the time and resource parameters for the one or more activated FH BWPs by excluding the deactivated one or more FH BWPs based on information included in the configuration from the network and the scheduling DCI and performing uplink (UL) or downlink (DL) communications on the first channel in the activated first BWP and the determined one or more activated FH BWPS.

In a thirty seventh example, a processor of a base station is configured to perform operations comprising transmitting a configuration to a user equipment (UE) for parameters including time and frequency resource parameters for a first bandwidth part (BWP) and frequency hopping (FH) parameters for a user equipment (UE) to determine time and resource parameters for one or more FH BWPs from the first BWP, transmitting a scheduling downlink control information (DCI) indicating the first BWP is activated for a first channel, transmitting an indication that at least one of the one or more FH BWPs is activated, wherein the UE determines the time and resource parameters for the one or more activated FH BWPs by excluding the deactivated one or more FH BWPs based on information included in the configuration from the network and the scheduling DCI, performing uplink (UL) or downlink (DL) communications on the first channel in the activated first BWP and the determined one or more activated FH BWPs.

In a thirty eighth example, the processor of the thirty seventh example, wherein the indication is carried in a medium access control (MAC) control element (MAC-CE).

In a thirty ninth example, the processor of the thirty eighth example, wherein the MAC-CE is a fixed size of one octet and is identified by a MAC sub-header with a dedicated Logical Channel Identifier (LCID).

In a fortieth example, the processor of the thirty ninth example, wherein a Cᵢ field indicates an activation or deactivation status for an iₜₕ FH BWP or sub-band.

In a forty first example, the processor of the thirty seventh example, wherein the indication is carried in the scheduling DCI.

In a forty second example, the processor of the forty first example, wherein a new bitmap field is added to the scheduling DCI, wherein each bit is used to indicate an activation or deactivation status for an iₜₕ FH BWP or sub-band.

In a forty third example, the processor of the forty first example, wherein the configuration transmitted to the UE further includes a set of FH BWP or sub-band lists for activating or deactivating and the indication selects one entry from the set.

In a forty fourth example, the processor of the forty third example, wherein the indication is provided by a dedicated frequency hopping indicator (FHI) field in the scheduling DCI.

In a forty fifth example, the processor of the forty fourth example, wherein the FHI field indicates an index of the FH BWP or sub-band list pattern to use for activating the one or more FH BWPs for communication with the UE.

In a forty sixth example, the processor of the thirty seventh example, wherein the one or more FH BWPs are selected for activation for co-existence with channels of other UEs located in the same component carrier.

In a forty seventh example, a base station comprises a transceiver configured to communicate with a user equipment (UE) and a processor communicatively coupled to the transceiver and configured to perform operations comprising transmitting a configuration to a user equipment (UE) for parameters including time and frequency resource parameters for a first bandwidth part (BWP) and frequency hopping (FH) parameters for a user equipment (UE) to determine time and resource parameters for one or more FH BWPs from the first BWP, transmitting a scheduling downlink control information (DCI) indicating the first BWP is activated for a first channel, transmitting an indication that at least one of the one or more FH BWPs is activated, wherein the UE determines the time and resource parameters for the one or more activated FH BWPs by excluding the deactivated one or more FH BWPs based on information included in the configuration from the network and the scheduling DCI, performing uplink (UL) or downlink (DL) communications on the first channel in the activated first BWP and the determined one or more activated FH BWPS.

In a forty eighth example, a processor of a user equipment (UE) is configured to perform operations comprising receiving a configuration from a network for parameters including time and frequency resource parameters for a first bandwidth part (BWP) and frequency hopping (FH) parameters for determining time and frequency resource parameters for one or more FH BWPs from the first BWP, receiving a scheduling downlink control information (DCI) indicating the first BWP is activated for a first channel, determining the time and frequency resource parameters for the one or more FH BWPs based on information included in the network configuration and the scheduling DCI, the determined time and frequency resource parameters including an interval value for FH comprising a number of slots where a same RB location of the BWP is maintained and performing uplink (UL) or downlink (DL) communications on the first channel in the activated first BWP and the determined one or more FH BWPs.

In a forty ninth example, the processor of the forty eighth example, wherein a set of interval values is hard-encoded in specification and the interval value is determined based on a channel type activated for the first BWP.

In a fiftieth example, the processor of the forty eighth example, wherein the operations further comprise receiving an indication that the FH BWPs are activated via a system information block 1 (SIB1) broadcast, UE-dedicated radio resource control (RRC) signaling, or a new scheduling DCI.

In a fifty first example, a user equipment (UE) comprises a transceiver configured to communicate with a network and a processor communicatively coupled to the transceiver and configured to perform operations comprising receiving a configuration from a network for parameters including time and frequency resource parameters for a first bandwidth part (BWP) and frequency hopping (FH) parameters for determining time and frequency resource parameters for one or more FH BWPs from the first BWP, receiving a scheduling downlink control information (DCI) indicating the first BWP is activated for a first channel, determining the time and frequency resource parameters for the one or more FH BWPs based on information included in the network configuration and the scheduling DCI, the determined time and frequency resource parameters including an interval value for FH comprising a number of slots where a same RB location of the BWP is maintained and performing uplink (UL) or downlink (DL) communications on the first channel in the activated first BWP and the determined one or more FH BWPs

In a fifty second example, a processor of a base station is configured to perform operations comprising transmitting a configuration to a user equipment (UE) for parameters including time and frequency resource parameters for a first bandwidth part (BWP) and frequency hopping (FH) parameters for a user equipment (UE) to determine time and frequency resource parameters for one or more FH BWPs from the first BWP, transmitting a scheduling downlink control information (DCI) indicating the first BWP is activated for a first channel, wherein the UE determines the time and frequency resource parameters for the one or more FH BWPs based on information included in the network configuration and the scheduling DCI, the determined time and frequency resource parameters including an interval value for FH comprising a number of slots where a same RB location of the BWP is maintained and performing uplink (UL) or downlink (DL) communications on the first channel in the activated first BWP and the determined one or more FH BWPs.

In a fifty third example, the processor of the fifty second example, wherein a set of interval values is hard-encoded in UE specification and the interval value is determined based on a channel type activated for the first BWP.

In a fifty fourth example, the processor of the fifty third example, wherein the set of interval values comprises {1,2,4,8}.

In a fifty fifth example, the processor of the fifty second example, wherein the operations further comprise transmitting the interval value in a system information block (SIB) broadcast.

In a fifty sixth example, the processor of the fifty fifth example, wherein the operations further comprise transmitting a new interval value in dedicated radio resource control (RRC) signaling to override the interval value received by the UE in the SIB broadcast.

In a fifty seventh example, the processor of the fifty second example, wherein the interval value is carried in the scheduling DCI.

In a fifty eighth example, the processor of the fifty seventh example, wherein two reserved bits in the scheduling DCI are used to indicate one from multiple hard-encoded interval values.

In a fifty ninth example, the processor of the fifty seventh example, wherein an interval value of one is indicated in a system information block 1 (SIB1) broadcast for a Msg2, Msg3 or Msg4 reception.

In a sixtieth example, the processor of the fifty second example, wherein the operations further comprise transmitting an indication that the FH BWPs are activated via a system information block 1 (SIB1) broadcast, UE-dedicated radio resource control (RRC) signaling, or a new scheduling DCI.

In a sixty first example, a base station comprises a transceiver configured to communicate with a user equipment (UE) and a processor communicatively coupled to the transceiver and configured to perform operations comprising transmitting a configuration to the UE for parameters including time and frequency resource parameters for a first bandwidth part (BWP) and frequency hopping (FH) parameters for a user equipment (UE) to determine time and frequency resource parameters for one or more FH BWPs from the first BWP, transmitting a scheduling downlink control information (DCI) indicating the first BWP is activated for a first channel, wherein the UE determines the time and frequency resource parameters for the one or more FH BWPs based on information included in the network configuration and the scheduling DCI, the determined time and frequency resource parameters including an interval value for FH comprising a number of slots where a same RB location of the BWP is maintained and performing uplink (UL) or downlink (DL) communications on the first channel in the activated first BWP and the determined one or more FH BWPs.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving a configuration from a network for parameters including time and frequency resource parameters for a first bandwidth part (BWP) and frequency hopping (FH) parameters for determining time and frequency resource parameters for one or more FH BWPs from the first BWP;
determining the time and frequency resource parameters for the one or more FH BWPs based in part on information included in the configuration from the network, the time and frequency resource parameters for the FH BWPs including at least a first physical resource block (PRB) offset between the first BWP and a first determined FH BWP;
receiving a scheduling downlink control information (DCI) indicating the first BWP and a subset of the determined FH BWPs are activated for a first channel; and
performing uplink (UL) or downlink (DL) communications on the first channel in the activated first BWP and the determined one or more FH BWPs.

2. The processor of claim 1, wherein the first PRB offset is defined relative to a smallest or largest RB index of the first BWP and configured via radio resource control (RRC) signaling.

3. The processor of claim 2, wherein a second PRB offset is determined between a smallest PRB or a largest RB index of the first BWP and a smallest PRB or a largest RB index of a second determined FH BWP.

4. The processor of claim 2, wherein a second PRB offset is determined between a smallest PRB or a largest RB index of the first determined FH BWP and a smallest PRB or a largest RB index of a second determined FH BWP.

5. The processor of claim 1, wherein first BWP is configured in a component carrier, wherein the operations further comprise:
dividing the component carrier into a number of sub-bands based on a size of the component carrier and a size of the sub-bands expressed in units of PRBs, wherein the first BWP is carried in a first sub-band and each of the one or more FH BWPS is carried in a respective further sub-band.

6. The processor of claim 1, wherein first BWP is configured in a component carrier, wherein the operations further comprise:
dividing the component carrier into a number of sub-bands based on a size of the component carrier and a size of the sub-bands expressed in units of PRBs, wherein the first BWP is carried in a first sub-band and each of the one or more FH BWPs is carried in a respective further sub-band, wherein the network configuration further includes a set of candidate values for the size of the sub-bands;
receiving an indication of one of the set of candidate values, wherein the indication of one of the set of candidate values is received in a system information block 1 (SIB1).

7. The processor of claim 1, wherein first BWP is configured in a component carrier, wherein the operations further comprise:
dividing the component carrier into a number of sub-bands based on a size of the component carrier and a size of the sub-bands expressed in units of PRBs, wherein the first BWP is carried in a first sub-band and each of the one or more FH BWPs is carried in a respective further sub-band, wherein the network configuration further includes a set of candidate values for the size of the sub-bands, wherein the network configuration further includes a starting PRB of one of the sub-bands having a lowest RB index.

8. A processor of a user equipment (UE) configured to perform operations comprising:
receiving a configuration from a network for parameters including time and frequency resource parameters for a first bandwidth part (BWP) and frequency hopping (FH) parameters for determining time and resource parameters for one or more FH BWPs from the first BWP;
receiving a scheduling downlink control information (DCI) indicating the first BWP is activated for a first channel;
receiving an indication that at least one of the one or more FH BWPs is activated;
determining the time and resource parameters for the one or more activated FH BWPs by excluding the deactivated one or more FH BWPs based on information included in the configuration from the network and the scheduling DCI; and
performing uplink (UL) or downlink (DL) communications on the first channel in the activated first BWP and the determined one or more activated FH BWPs.

9. The processor of claim 8, wherein the indication is carried in a medium access control (MAC) control element (MAC-CE).

10. The processor of claim 9, wherein the MAC-CE is a fixed size of one octet and is identified by a MAC sub-header with a dedicated Logical Channel Identifier (LCID).

11. The processor of claim 10, wherein a Cᵢ field indicates an activation or deactivation status for an iₜₕ FH BWP or sub-band.

12. The processor of claim 8, wherein the indication is carried in the scheduling DCI.

13. The processor of claim 12, wherein a new bitmap field is added to the scheduling DCI, wherein each bit is used to indicate an activation or deactivation status for an iₜₕ FH BWP or sub-band.

14. A processor of a user equipment (UE) configured to perform operations comprising:
receiving a configuration from a network for parameters including time and frequency resource parameters for a first bandwidth part (BWP) and frequency hopping (FH) parameters for determining time and frequency resource parameters for one or more FH BWPs from the first BWP;
receiving a scheduling downlink control information (DCI) indicating the first BWP is activated for a first channel;
determining the time and frequency resource parameters for the one or more FH BWPs based on information included in the network configuration and the scheduling DCI, the determined time and frequency resource parameters including an interval value for FH comprising a number of slots where a same RB location of the BWP is maintained; and
performing uplink (UL) or downlink (DL) communications on the first channel in the activated first BWP and the determined one or more FH BWPs.

15. The processor of claim 14, wherein a set of interval values is hard-encoded in specification and the interval value is determined based on a channel type activated for the first BWP, wherein the set of interval values comprises {1,2,4,8}.

16. The processor of claim 14, wherein the operations further comprise:
receiving the interval value in a system information block (SIB) broadcast.

17. The processor of claim 16, wherein the operations further comprise:
receiving a new interval value in dedicated radio resource control (RRC) signaling to override the interval value received in the SIB broadcast.

18. The processor of claim 14, wherein the interval value is carried in the scheduling DCI.

19. The processor of claim 18, wherein two reserved bits in the scheduling DCI are used to indicate one from multiple hard-encoded interval values.

20. The processor of claim 18, wherein an interval value of one is indicated in a system information block 1 (SIB1) broadcast for a Msg2, Msg3 or Msg4 reception.
